(19) United States
(12) Patent Application Publication
(10) Pub. No.: US 2008/0030510 A1
(43) Pub. Date: Feb. 7, 2008

(54) Multi-GPU rendering system

(75) Inventors: Min-Chuan Wan, Hsinchu City (TW); His-Jou Deng, Hsinchu City (TW); Chuncheng Lin, Hsinchu City (TW)

Correspondence Address: John Chen;Room 303, 3F., No 25, Sec. 1, Changan E. Road, Taipei, 10441, omitted

(73) Assignee: XGI Technology Inc.

(21) Appl. No.: 11/497,417

(22) Filed: Aug. 2, 2006

(51) Int. Cl. G06F 15/80

(52) U.S. Cl. 345/505

(57) ABSTRACT

A multi-GPU rendering system according to a preferred embodiment of the present invention includes a CPU, a chipset, the first GPU (graphics processing unit), the first graphics memory for the first GPU, a second GPU, and the second graphics memory for the second GPU. The chipset is electrically connected to the CPU, the first GPU and the second GPU. Graphics content is divided into two parts for the two GPUs to process separately. The two parts of the graphics content may be the same or different in sizes. Two processed graphics results are combined in one of these two graphics memories to form complete image stream and then it is outputted to a display by the GPU.

### BACKGROUND OF THE PRESENT INVENTION

1. Field of Invention

The present invention relates to a graphics processing system having a plurality of graphics processing unit (GPU), used for asymmetric load balancing and operating efficiency increasing and performance improvement, and more particularly, to a graphics processing system with multiple GPUs utilizing a system memory to assisting data access.

2. Description of Related Arts

As the need from market for better qualities in computer graphics, particularly for three-dimension (3D) and real-time computer graphics, has increased. Many methods applied for rising the speed and quality in computer graphics have become widespread. In the arts, the field utilizing multiple GPUs to accelerate graphics processing is one of the most important subdivisions. It can be found that there are several technical difficulties needed to be overcome to implement a multi-GPU rendering system. First, the rendering commands need to be divided between each of the GPUs in the multi-GPU rendering system. Next, image information outputs of the GPUs should be synchronizing. Finally, a method or an apparatus of merging the image information that is rendered on each of the GPUs to a specific one of the GPUs for outputting complete image data to a display device is also required.

However, there are many unsolved drawbacks relating to the prior arts. For example, almost all of the graphics rendering systems with multiple GPUs divide the load of the graphics processing equally without respect to the performance difference between GPUs. Furthermore, because of the use of added cables or chips or circuits to electrically connect the GPUs for image combination or communication, most of graphics rendering systems with multiple GPUs in the prior arts are complex and costly. Moreover, only a few chipsets can be supported specifically for matching the multi-GPU rendering system, which reduces the generality of the motherboard and also raises the manufacturing cost.

In addition, for business and technical reasons, the multi-GPU rendering systems in prior arts are usually consisted of GPUs made by the same manufacturer or limited to the same GPU core, which forbid the choosing flexibility of customers.

Therefore, it is desirable to have an efficient rendering system and method for decreasing cost, simplifying system assembly and applying flexibly. It is also desirable to have an efficient rendering system and method to solve the limitation of symmetric load balancing and the use of adding hardware.

### SUMMARY OF THE PRESENT INVENTION

An object of the present invention is to provide a multi-GPU rendering system integrating image information to a display device by using a main memory and a chipset having bidirectional transmitting functions.

A further object of the present invention is to provide a multi-GPU rendering system to increase the performance of the system without the need to adding extra hardware.

A further object of the present invention is to provide a multi-GPU rendering system to increase the performance by symmetrically or asymmetrically balancing the load of graphics processing.

A further object of the present invention is to provide a multi-GPU rendering system without the need to specify the employed chipset or GPUs.

Additional objects and advantages of the invention will be set forth in part in the description which follows and, in part, will be obvious from the description, or may be learned by the practice of the invention,

Accordingly, in order to accomplish the one or some or all above objects, the present invention provides a multi-GPU rendering system, comprising:
A multi-GPU rendering system, comprising:
a CPU;
a first graphics processing unit (GPU);
a second GPU;
a chipset electrically connected to the CPU, the first GPU, and the second GPU;
a first graphics memory for the first GPU; and
a second graphics memory for the second GPU;
the CPU divides a graphics content into a first part of the graphics content for the first GPU to process and a second part of the graphics content for the second GPU to process, and then a first processed result comes from the first GPU and a second processed result comes from the second GPU;
the first processed result is stored in the first graphics memory, and the second processed result is stored in the second graphics memory; and
the second processed result is transferred from the second graphics memory to the first graphics memory via the chipset and a memory device;
the first processed result and the second processed result in the first graphics memory are combined to form an output result; and
the first GPU gets the output result from the first graphics memory and displays the output result.

One or part or all of these and other features and advantages of the present invention will become readily apparent to those skilled in this art from the following description wherein there is shown and described a preferred embodiment of this invention, simply by way of illustration of one of the modes best suited to carry out the invention. As it will be realized, the invention is capable of different embodiments, and its several details are capable of modifications in various, obvious aspects all without departing from the invention. Accordingly, the drawings and descriptions will be regarded as illustrative in nature and not as restrictive.

### BRIEF DESCRIPTION OF THE DRAWINGS

FIG. 1 is a schematic diagram of a multi-GPU rendering system.

FIG. 2 is a block diagram illustrating the flow chart of the command streams issued by a CPU according to a preferred embodiment of the present invention.

FIG. 3 illustrates a processing diagram of the multi-GPU rendering system according to a preferred embodiment of the present invention.

### DETAILED DESCRIPTION OF THE PREFERRED EMBODIMENT

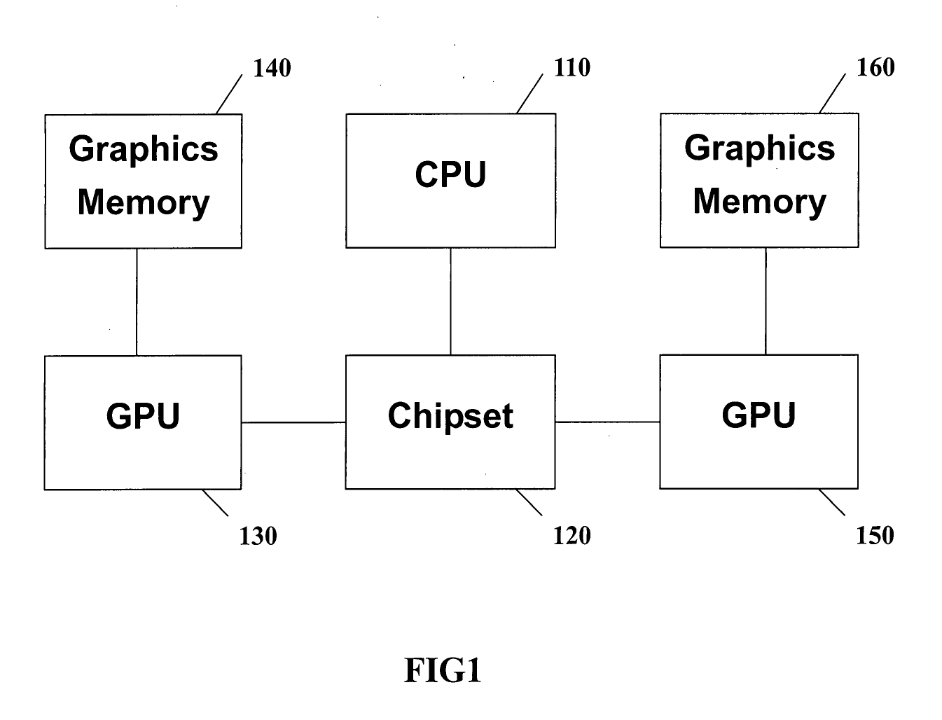

Referring to FIG. 1, it is a block diagram of a multi-GPU rendering system 100 according to a preferred embodiment of the present invention. The multi-GPU rendering system 100 includes a CPU 110, a chipset 120, the first GPU (graphics processing unit) 130, the graphics memory 140 (such as a local frame buffer, LFB, or a shared memory in a main memory) for the first GPU 130, a second GPU 150, and the graphics memory 160 (such as a LFB) for the second GPU 150. The second GPU 150 and the graphics memory 160 may be included in a printed card, such as a graphics card (not shown). The chipset 120 is electrically connected to the CPU 110, the first GPU 130 and the second GPU 150.

The first GPU 130 may be integrated in the chipset 120 as an IGP (integrated processing platform), or a discrete device out of the chipset 120. The number of the GPUs is not limited. But in this embodiment, two GPUs including the first GPU 130 and the second GPU 150 are employed to illustrate how to work on a graphics context.

The CPU 110 divides graphics content into two parts for the two GPUs, such as a frame for the GPU 130 and a frame for the GPU 150, the upper frame for the GPU 130 and the lower frame for the GPU 150, and an odd line for the GPU 130 and an even line for the GPU 150. The above methods are symmetric loading for the two GPUs. Or the graphics content is divided into two parts with different sizes, such as ⅓ frame and the rest ⅔ frame, asymmetric loading for the two GPUs. A part of the graphics content is sent to the GPU 130 to process, and the processed result of the GPU 130 is sent to the graphics memory 140 to store. The other part of the graphics content is sent to the GPU 150 to process, and also the processed result of the GPU 150 is sent to the graphics memory 160 to store.

The processed result of the second GPU 150 is sent to a memory device (not shown) from the second graphics memory 160 via the chipset 120 if a display is connected to the first GPU 130. The memory device may be a main memory electrically connected to the chipset 120 or the CPU 110. And then the processed result of the second GPU 150 is sent to the first graphics memory 140 from the memory device to be combined with the other processed graphics content of the first GPU 130 which is also stored in the first graphics memory 140. Finally, the first GPU 130 gets the combined processed result from the first graphics memory 140 and then output it to the display.

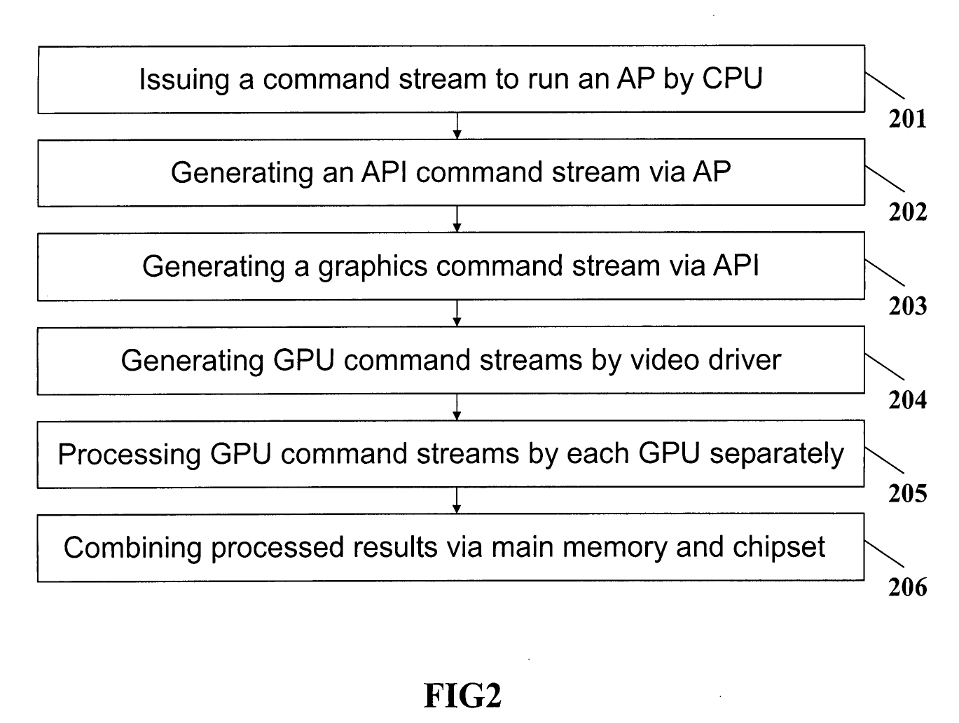

Referring to FIG. 2, it is an embodiment to illustrate the flow chart of the present invention. It is the flow chart to show how the multi-GPU rendering system works on graphics content. In this embodiment, there are only two GPUs, but not limited.

In step 201, a CPU issues a command stream to run an application program (AP), such as a game. In step 202, An API command stream is generated via the AP. In step 203, an API (application program interface), such as an OpenGL or Direct X, receives the API command stream, and generates a graphics command stream for a video driver (or called a graphics driver). In step 204, the video driver receives the graphics command stream and then generates the first GPU command stream for the first GPU and the second GPU command stream for the second GPU. In step 205, the first GPU command stream is sent to the first GPU and the second GPU command stream is sent to the second GPU. The two GPUs process the two GPU command streams separately. In step 206, the processed results of the GPU commands are combined via a chipset and a memory device to output to a display.

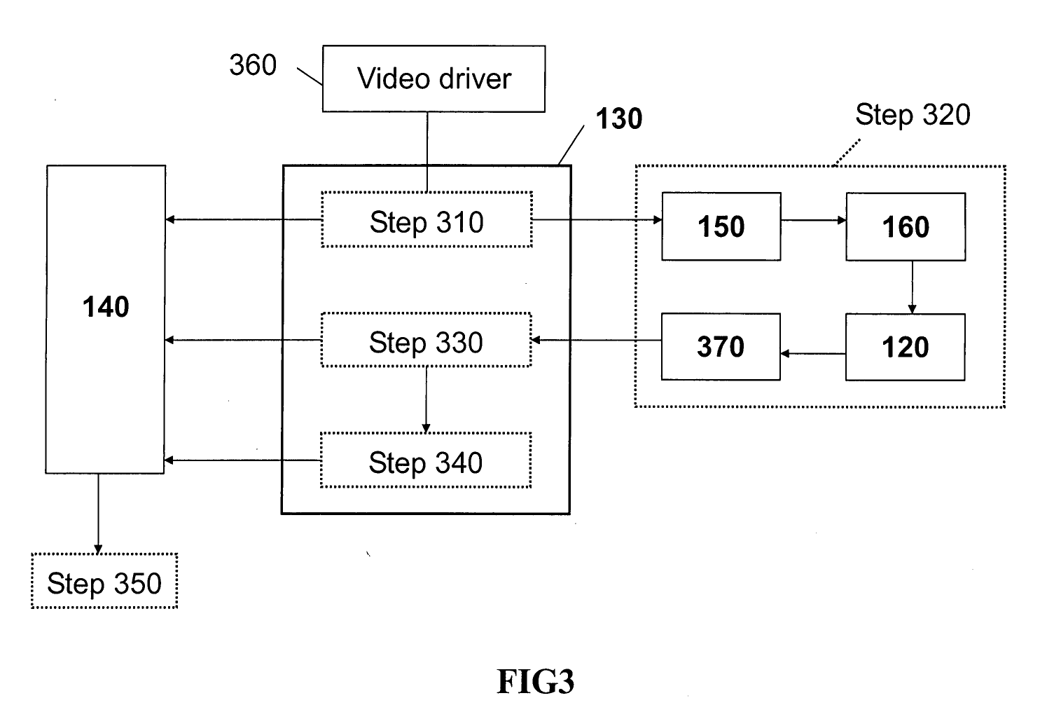

FIG. 3 illustrates a processing diagram 300 of a multi-GPU rendering system according to a preferred embodiment of the present invention. At step 310, the video driver 360 inputs the GPU command stream relating to a frame N to the first GPU 130. The first GPU 130 processes the GPU command stream relating to a frame N and outputs an image signal of frame N to the first graphics memory 140. At the step 320, the video driver 360 inputs the GPU command stream relating to a frame N+1 to the second GPU 150, The second GPU 150 processes the GPU command stream relating to a frame N+1 and outputs an image signal of frame N+1 to the second graphics memory 160, then use the chipset 120 to transfer the image signal relating to frame N+1 to the main memory 370. At the step 330, the first GPU 130 stores the image signal relating to frame N+1 of the main memory 370 to the first graphics memory 140. At the step 340, the video driver 360 inputs the GPU command stream relating to a frame N+2 to the first GPU 130. The first GPU 130 processes the GPU command stream relating to a frame N+2 and outputs an image signal of frame N+2 to the first graphics memory 140. At step 350, the first GPU 130 outputs the image signal stored in the first graphics memory 140 to the display device sequentially. The step disclosure above will be executed repeatedly until the processes for the GPU command stream from the video driver 360 are done.

The video driver uses the commands such as Ready, Go and Wait to enable the two GPUs alternately for the synchronization between the two GPUs. When one GPU is enabled, the other one is waiting by the use of the command “Wait”. When the processes executing in the GPU are done, it transmits a command “Go” to the video driver 360. The video driver 360 transmits a command “Go” to the other GPU to enable the other GPU. Moreover, it will be understood by those skilled in the art that the executing sequence and the mass or structure of the data processed in the above steps can be dynamically modified but not limited to the sequence and structure disclosure in this embodiment. Furthermore, the video diver 360 can be implemented by the use of hardware, such as Integrated Circuit, IC, which depends on the demands of user.

In conclusion, the present invention uses a video driver to implement the distribution of GPU command streams, and then accelerates graphics processes by switching the GPUs. The present invention also uses a method to integrate data by the way of writing into/reading from the main memory for accessing the processed data and the use of a chipset having abilities of bidirectional data transmission among the CPU and the main memory and the GPUs. The present invention provides a multi-GPU rendering system without using any adding connector to the GPUs in the graphics processing system, any adding elements for integrating and synchronizing image information, or GPUs having the same performance. The multi-GPU rendering system is also not limited by GPUs using the same core or manufactured by the same manufacturer.

One skilled in the art will understand that the embodiment of the present invention as shown in the drawings and described above is exemplary only and not intended to be limiting.

The foregoing description of the preferred embodiment of the present invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A multi-GPU rendering system, comprising:
a CPU;
a first graphics processing unit (GPU);
a second GPU;
a chipset electrically connected to the CPU, the first GPU, and the second GPU;
a first graphics memory for the first GPU; and
a second graphics memory for the second GPU;
the CPU divides a graphics content into a first part of the graphics content for the first GPU to process and a second part of the graphics content for the second GPU to process, and then a first processed result comes from the first GPU and a second processed result comes from the second GPU;
the first processed result is stored in the first graphics memory, and the second processed result is stored in the second graphics memory; and
the second processed result is transferred from the second graphics memory to the first graphics memory via the chipset and a memory device.

2. The multi-GPU rendering system as recited in claim 1, wherein the first processed result and the second processed result in the first graphics memory are combined to form an output result.

3. The multi-GPU rendering system as recited in claim 2; wherein the first GPU gets the output result from the first graphics memory and displays the output result.

4. The multi-GPU rendering system as recited in claim 1, wherein the first GPU is integrated in the chipset.

5. The multi-GPU rendering system as recited in claim 1; wherein the first GPU is discrete out of the chipset.

6. The multi-GPU rendering system as recited in claim 4; wherein the first graphics memory comprises a shared memory in a main memory.

7. The multi-GPU rendering system as recited in claim 4, wherein the first graphics memory comprises a local frame buffer (LFB).

8. The multi-GPU rendering system as recited in claim 1, wherein the first part of the graphics content is not the same as the second part of the graphics content in size.

9. The multi-GPU rendering system as recited in claim 1, wherein the first part of the graphics content is the same as the second part of the graphics content in size.

10. A multi-GPU rendering method, comprising:
issuing a first command stream to run an application program (AP);
generating a API command stream via the AP;
an application program interface (API) generating an graphics command stream in accordance with the API command stream;
a video driver generating a first GPU command stream for the first GPU and the second GPU command stream for the second GPU in accordance with the graphics command stream;
the first GPU and the second GPU processing the graphics content in accordance with the first and the second GPU command streams to obtain a first processed result from the first GPU and a second processed result from the second GPU; and
the second processed result is sent to be combined with the first processed result via a chipset and a memory device to obtain an output result; and displaying the output result.

11. The multi-GPU rendering method as recited in claim 10, wherein a CPU runs an application program (AP).

12. The multi-GPU rendering method as recited in claim 10, wherein the CPU generates a first command stream.

13. The multi-GPU rendering method as recited in claim 10, wherein the first GPU processes the first part of the graphics content and the second GPU processes the second part of the graphics content in accordance with the first and second GPU command streams separately.
